(19) United States
(12) Patent Application Publication
(10) Pub. No.: US 2018/0149549 A1
(43) Pub. Date: May 31, 2018

(54) Leak Detection System

(71) Applicant: Anthony Gonzales, Pahrumot, NV (US)

(72) Inventor: Anthony Gonzales, Pahrumot, NV (US)

(21) Appl. No.: 14/750,863

(22) Filed: Jun. 25, 2015

(51) Int. Cl. G01M 3/20; G01N 21/78

(52) U.S. Cl. CPC G01M 3/20; G01N 21/78

(57) ABSTRACT

A leak detection system includes a roofing membrane and an indicator compound configured to be in contact communication with a roofing membrane. The indicator compound is configured to change color upon contact with water leaking from a surface of the roofing membrane to indicate a spot of leakage on the roofing membrane. In an embodiment, the indicator compound is impregnated into a material of the roofing membrane, thereby the color change of the indicator compound is observed on the surface of the roofing membrane. In another embodiment, the indicator compound is coated between layers of the roofing membrane. In an embodiment, the indicator compound is impregnated or coated into a fabric sheet positioned between layers of the roofing membrane.

### BACKGROUND

Checking for roof leaks in domestic and commercial buildings can be time-consuming and tedious because the exact point of actual leak is often difficult to identify. It often requires several attempts to identify and rectify the leak that is allowing the entry of water inside the building wall or a roof. Conventionally, a few systems are adopted by maintenance managers for leak detection and repair. In most cases, a roof leak first shows itself as a spot of water on the floor or a wet ceiling tile. Maintenance team marks these spots with tape or a marker. Even then, the precise location of a leak can become uncertain and hard to identify after an extended period of leakage. The most suitable time selected by a maintenance team to spot a leak is when the water is still in the flowing mode because if the water dries out, it becomes difficult to spot the origin point of the leak, therefore following the water path generally is easier during a search for the leakage source.

Generally, the initial step in leak detection is to find the point at which water through the roofing system and becomes visible inside the building surface such as under the ceiling. In order to detect such leakage, a worker performing the leak inspection might need to remove ceiling tiles and access sections above piping and ductwork. Successful detection of the leak requires thorough access to the bottom of the roof deck and substantial light to illuminate the bottom roof deck section. After the worker locates the entry point of the leakage water, the next step is to locate the point of the leak. The worker determines the distance the water travels inside the roofing system by using a tape from exterior walls, roof drain systems, or other roof openings that are easily identifiable from inside and outside the building.

Even after performing such careful steps, it should be noted that leaks travel a considerable distance within the roof system or on deck. In such cases, the interior water exit point might be a considerable distance away from the rooftop water entry point. Further, to determine direction the water traveled and to visually examine the moisture path, the worker might need to drill openings in the metallic rib sections or remove roofing materials. In other cases, infra-red detection systems which comprise thermal imaging is also used to check for leakage where the worker pans an infra-red thermal imaging camera along the roof surface, where a significant change in the thermal image generated at a particular point shows a leakage at that section. In above mentioned systems, a worker has to manually do a certain number of steps to finally find out the leakage point, certain type of machinery has to be used in order to continue with further leakage checks, and the entire leak check process is again time consuming.

Hence, there is a long felt but unresolved need for a low cost leak detection system which can spot a leak immediately as the leak is generated, which is less time consuming, and does not require any kind of machinery to find the leak initiation point.

### SUMMARY OF THE INVENTION

The leak detection system disclosed herein addresses the above stated needs for spotting a leak immediately as the leak is generated, which is less time consuming, and does not require any kind of machinery to find the leak initiation point. The leak detection system comprises a roofing membrane and an indicator compound. The indicator compound configured to be in contact communication with the roofing membrane, where the indicator compound configured to change color upon contact with water leaking from a surface of the roofing membrane to indicate a spot of leakage on the surface of the roofing membrane.

In an embodiment, the indicator compound is impregnated into a material of the roofing membrane, thereby the color change of the indicator compound is observed on the surface of the roofing membrane. In another embodiment, the indicator compound is coated between layers of the roofing membrane. In an embodiment, the indicator compound is impregnated or coated into a fabric sheet positioned between layers of the roofing membrane.

### BRIEF DESCRIPTION OF THE DRAWINGS

FIG. 1A exemplarily illustrates a top perspective view of a house, showing a leakage on the roofing membrane.

FIG. 1B exemplarily illustrates a top perspective enlarged view of a portion of FIG. 1A, showing a leak detection system.

FIG. 1C exemplarily illustrates a bottom perspective enlarged view of the portion of FIG. 1A, showing the leak detection system.

FIG. 2 exemplarily illustrates a top perspective view of the layers of the roofing membrane showing the fabric sheet positioned between the layers.

### DETAILED DESCRIPTION OF THE INVENTION

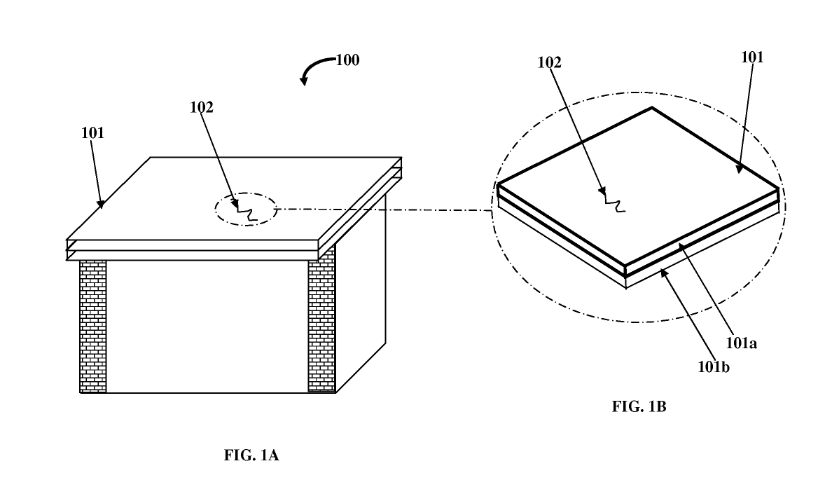

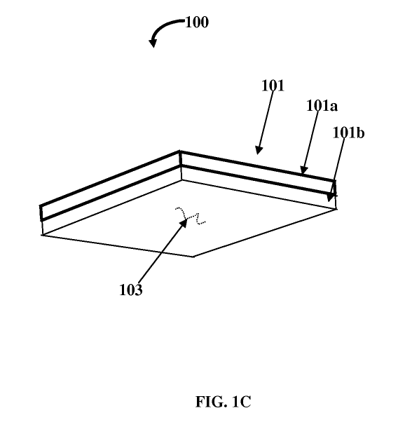

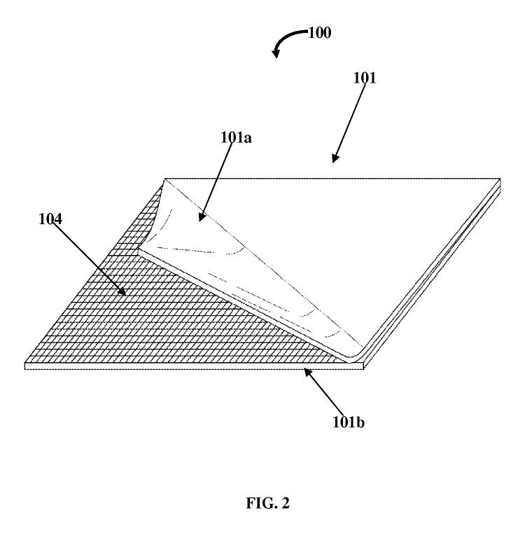

FIG. 1A exemplarily illustrated a top perspective view of a house, showing a leakage 102 on the roofing membrane 101. The leakage on the roofing membrane 101 can be caused due to natural factors such as heat, wind turbulence, rainfall, hailstorm, etc. The leakage on the roofing membrane 101 can also be caused by other factors, for example, impact from external heavy objects. As shown in FIG. 1A, water percolates through the leakage 102, due to cracks or breakage formed on the roofing membrane 101. The water enters through the leakage 102, and then spreads through the inner face or bottom surface of the roofing membrane 101 towards the walls and support columns inside the house or drips from the ceiling onto the floor. This leakage 102 should be detected at the earliest as possible. Further, the precise point of leakage 102 has to be detected as well to stop the water leakage immediately. Therefore, the present leakage detection system comprises an fabric sheet 104, for example, polyester fabric, fabric reinforcement sheet, which is impregnated or coated with an indicator compound, configured to be placed between layers 101a and 101b the roofing membrane 101 to instantly detect and repair the leakage 102 as disclosed in the detailed description of FIG. 1B, FIG. 1C and FIG. 2. In another embodiment, the indicator compound is coated between layers 101a and 101b of the roofing membrane 101.

FIGS. 1B-1C exemplarily illustrate a top perspective view and a bottom perspective enlarged views of a portion of FIG. 1A, showing a leak detection system 100. The leak detection system 100 comprises layers 101a and 101b of roofing membrane 101 and a fabric sheet 104 containing an indicator compound as shown in FIG. 2. In an embodiment, the roofing membrane 101 comprises one of a polyester fabric and any other fabric used in the manufacturing of thermo plastic roof membranes and other systems, such as torch roof systems, built up roofing system, other similar water proofing systems. The roofing membrane 101 is typically made of, for example, a thermoplastic membrane which is similar to synthetic rubber, but where the seams are generally heat-fused or welded to form a continuous membrane. Further, the seams can also be fused with solvents instead of heat, and can form strong membrane. In another example, the roofing membrane 101, or the thermoplastic roofing membrane 101 is made of a combination of thermoplastic coated metal reinforcements. A thermoplastic, for example, a polyvinyl chloride (PVC) layer is welded along with the metallic reinforcements. The thermoplastic layer can have a thickness of, for example, about 0.1 inches to 0.5 inches. The coated metal reinforcements are configured to be attached to the roofing membrane 101 via welding the thermoplastic layer to the roofing membrane.

The indicator compound configured to be in contact communication with a roofing membrane 101, where the indicator compound configured to change color upon contact with water leaking from a surface of the roofing membrane 101 to visually indicate a section of leakage 102 on the surface of the roofing membrane 101. As exemplarily illustrated in FIGS. 1A-1B and FIG. 2, in an embodiment, the indicator compound is impregnated or coated into a fabric sheet 104, where the fabric sheet 104 positioned between layers 101a and 101b of the roofing membrane 101, such that water entering through the leakage spot of the roofing membrane 101 comes into contact with the fabric sheet 104 and produce a color change, thus visually indicating the spot of leakage. The fabric sheet 104 is sandwiched between layers 101a and 101b of the roofing membrane 101. The fabric sheet 104 is further fastened at the edges of the roofing membrane 101 to provide additional support for the attachment.

FIG. 2 exemplarily illustrates a top perspective view of the layers 101a and 101b of the roofing membrane 101 showing the fabric sheet 104 positioned between the layers 101a and 101b. When the water enters through the leakage 102, the water makes contact with the fabric sheet 104 positioned in between the layers 101a and 101b and an impression 103, as shown in FIG. 1C is formed on the fabric sheet 104 when the indicator compound in the fabric sheet 104 reacts with the water which indicates the position of the leakage 102 on the surface of the roofing membrane 101. In an embodiment, the indicator compound is impregnated into the roofing membrane 101, thereby the color change or the impression 103 caused by the reaction between the water and indicator compound is observed on the roofing membrane 101 itself. That is, the indicator compound being a water soluble material that is built into or around a plastic fabric which is used in the manufacturing of roofing material. Therefore the solution to detect a leak is already built into the product or the leak detection system 100 in this embodiment.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A leak detection system comprising:
a multi-layer material having an outer layer, wherein the outer layer is a roofing membrane, wherein at least one layer of the multi-layer material is a fabric layer in communication with the outer layer;
an indicator compound impregnated within the fabric layer, wherein the indicator compound reacts with water, wherein the indicator compound changes color when contacted by water, and wherein the change in color indicates a spot of leakage on a surface of the roofing membrane.

2. The leak detection system of claim 1, wherein the indicator compound is impregnated into the outer layer, wherein the color change visible on an exterior surface of the roofing membrane.

3. The leak detection system of claim 2, wherein the multi-layer material has a second roofing membrane, wherein the indicator compound is coated between the outer layer and the second roofing membrane, wherein the fabric layer is positioned between the outer layer and the second roofing membrane.

4. The leak detection system of claim 2, wherein the indicator compound is impregnated and coated into each of the fabric layer and the outer layer.

5. The leak detection system of claim 3, wherein the roofing membrane is polyester fabric.

6. The leak detection system of claim 1, wherein the water reacts with the indicator compound when the water leaks through the outer layer.
